(19) United States
(12) Patent Application Publication
(10) Pub. No.: US 2025/0257683 A1
(43) Pub. Date: Aug. 14, 2025

(54) TUBULAR STRUCTURE ADAPTED TO AT LEAST PARTLY ENCLOSE A PENCIL COIL FOR INTERNAL COMBUSTION ENGINES

(71) Applicant: SEM AB, Åmål (SE)

(72) Inventors: Jakob Ängeby, Karlstad (SE); Johan Tidholm, Åmål (SE)

(73) Assignee: SEM AB, Åmål (SE)

(21) Appl. No.: 18/859,899

(22) PCT Filed: Apr. 26, 2023
(86) PCT No.: PCT/EP2023/060876

§ 371 Date: Oct. 24, 2024

(30) Foreign Application Priority Data
May 2, 2022 (SE) 2250534-1

(51) Int. Cl. F02B 23/08; F02B 5/00; F02B 77/00; F02P 3/01; F02P 3/02; H01F 38/12

(52) U.S. Cl. CPC F02B 23/08; F02B 5/00; F02B 77/00; F02P 3/01; F02P 3/02; H01F 38/12

(57) ABSTRACT

A tubular structure (100) adapted to connect a valve cover (200) of an internal combustion engine (300) to a portion (310) of the internal combustion engine (300) is disclosed. The portion (310) encircles a spark plug connection interface (320). The tubular structure (100) is adapted to protect an ignition coil (400) from oil for lubrication of parts coverable by the valve cover (200). The ignition coil (400) is mountable at least partly within the tubular structure (100), whereby the tubular structure (100) is capable of forming part of a magnetic shield for shielding the ignition coil (400). The tubular structure (100) comprises a soft magnetic material and wherein at least a portion (106) of the tubular structure (100) has a relative permeability greater than 10 and a resistivity greater than 0.3 μΩm. The portion (106) of the tubular structure (100) extends along and at least partially overlaps with a longest winding of the ignition coil (400) as seen in the longitudinal direction of the ignition coil (400), when the ignition coil (400) and the tubular structure (100) are mounted in the internal combustion engine (300).

### TECHNICAL FIELD

Embodiments herein relate to internal combustion engines with spark ignition (SI-ICE) and parts therefor, such as cover parts therefore. In particular, a tubular structure, adapted to connect to a valve cover of an internal combustion engine, is disclosed.

### BACKGROUND

Within SI-IC engines, an ignition coil is used to generate a high voltage that creates a spark, which ignites fuel fed to the engine. The ignition coil is built up like a transformer with the following main parts that design the electro-magnetic properties of the ignition coil: a primary and a secondary bobbin with a primary and a secondary winding, respectively, a soft magnetic core, and a magnetic shield.

In many cases it is highly desirable to fit the ignition coil in a so-called spark plug well of packaging reasons, because space is a very limited resource in-and outside a modern SI-ICE. Such a coil is denoted a “pencil coil”. A known pencil coil comprises a core, a primary winding, a secondary winding, and a magnetic shield.

Pencil coils are made narrow such that the entire coil fits into the sparkplug well of an SI-ICE. The sparkplug well is typically of a tubular shape and forms a cavity from the spark plug to the valve cover top. Hereby, the spark plug can be reached and serviced from the top of the engine, without removing a valve cover. The valve cover covers and at least partly encloses moving mechanical parts, lubricated by oil that is pumped over them. An outer surface of the tubular shape that forms the spark plug well, i.e., the outer surface faces the moving mechanical parts, is wetted by the lubrication oil, and hereby cooled.

There are multiple challenges when designing an ignition coil. One of the challenges relate to how to design the magnetic circuit, i.e., the design of the core and magnetic shield such that the magnetic field is guided along a path with high permeability and resistivity. The high permeability is needed in order to easily build and transmit magnetic fields, and the high resistivity is needed in order to reduce eddy currents that are generated by the magnetic field. The eddy currents cause energy losses in the form of heat that needs to be dissipated in order to cool the ignition coil. Additional energy losses are caused by heat originating from e.g. the core, the primary and secondary windings etc. Further, the ignition coil is heated due to generation of sparks. Notably, a great part of the heat originates from the eddy currents in the magnetic shield. In some cases, as much as 50% of a total heat generation originates from the magnetic shield. Due to the limited space, the magnetic shield may be made using a thin plate. However, a thin plate will have a higher magnetic flux density compared to a thicker plate with the same magnetic flux. This makes a thinner plate more magnetic saturated, which will result in more leakage flux. Even more, the change in flux per area unit will be grater in the thinner plate, which correlates to larger eddy currents and thereby more heat losses.

A magnetic shield is often manufactured using transformer plate. As per the reasoning above, a thick plate is preferred to a thin.

Heat dissipation is a general challenge when designing ignition coils, but the challenge becomes accentuated when designing a pencil coil due to geometrical constraints when fitting the ignition coil in the spark plug well. The environment within the spark plug well is hot and has limited heat dissipation. The geometry of a pencil coil, i.e., narrow and long, makes it challenging to design the magnetic circuit such that a high enough efficiency is achieved. As commonly known, the efficiency relates to a ratio of output energy to supplied energy, which e.g. is dependent on the design of e.g. the core, the primary and secondar windings. As a consequence, the heat generation in a pencil coil is relatively high. It is a challenge to handle the more than usual generated heat, which in combination with being mounted in the hot non ventilated narrow space, may deteriorate the material in the assembly and lead to a break-down. Also, the scarce space available makes it very difficult to find space enough for adequate electrical insulation, which may lead to break down and failure of the pencil coil, even if the heat could be handled somehow. It is also a challenge to find space enough to insulate the extremely high electric fields and prevent break down through the dielectric insulation material.

### SUMMARY

An object may be to eliminate, or at least reduce, one or more the abovementioned disadvantages and/or problems.

According to an aspect, the object is achieved by a tubular structure adapted to connect a valve cover of an internal combustion engine to a portion of the internal combustion engine, wherein the portion encircles a spark plug connection interface, wherein the tubular structure is adapted to protect an ignition coil from oil for lubrication of parts coverable by the valve cover, wherein the ignition coil is mountable at least partly within the tubular structure, whereby the tubular structure is capable of forming part of a magnetic shield for shielding the ignition coil, wherein the tubular structure comprises a soft magnetic material and wherein at least a portion of the tubular structure has a relative permeability greater than 10 and a resistivity greater than 0.3 μΩm. The portion of the tubular structure extends along and at least partially overlaps with a longest winding of the ignition coil, e.g. out of a primary and secondary winding thereof, as seen in the longitudinal direction of the ignition coil, when the ignition coil and the tubular structure are mounted in the internal combustion engine.

Thanks to that the tubular structure comprises a soft magnetic material, such as electrical steel, a soft magnetic composite, or the like, and has the relative permeability and the resistivity as specified above, the tubular structure is capable of forming part of a magnetic shield of an ignition coil mounted in the internal combustion engine. In this manner, a magnetic shield of the ignition coil, typically a pencil coil, may be reduced in size or even dispensed with as further elaborated on herein. As a result, the embodiments herein make it significantly simpler to construct an ignition coil, such as a pencil coil, that meets the requirements on space and solves one or more of the aforementioned challenges.

An advantage is hence that the tubular structure according to at least some embodiments herein makes it possible to make a pencil coil that may be made more cost efficient and of higher quality, e.g., in terms of durability and efficiency, as compared to a conventional pencil coil. As an example, the tubular structure may thus operate as the sole or an additional magnetic shielding of a pencil coil. Hence, the pencil coil itself is not required to be equipped with a magnetic shield, which makes space available for tuning of other parts, such as a core and primary/secondary windings to improve performance. This means that according to another aspect of the invention, there is provided a system comprising two separate parts. One of the two separate parts is a pencil coil without a built-in, or integrated, magnetic shielding. Notably, pencil coils available on the market are provided with built-in or integrated magnetic shields. The other one of the two separate parts is the tubular structure according to the embodiments disclosed herein.

The embodiments herein thus enable the manufacturing of a pencil coil with increased efficiency thanks to the release of additional space for the design of the pencil coil. As a result, decreasing heat generation and cost for achieving the same efficiency. In addition, cost of the pencil coil may be reduced thanks to the lack of an internal magnetic shield.

As indicated above, there is also provided a system comprising a first part and a second part, wherein the first and second parts are separable from each other, wherein the first part comprises a tubular structure according to the embodiment herein and the second part comprises a pencil coil lacking an internal or built-in magnetic shield.

There are many ways in which a soft magnetic material may be incorporated in the tubular structure. For example, the tubular structure may comprise over-mould stripes of a soft magnetic material, such as electrical steel, transformer plate, or the like. As a further example, a soft magnetic powder may be mixed with plastic and then moulded to form the tubular structure upon solidification, i.e. the tubular structure is at least partly made of a soft magnetic composite.

In some embodiments, the tubular structure comprises one or more sheets of electrical steel. Said one or more sheets are arranged to conform to the tubular structure. e.g. the shape of the tubular structure. The tubular structure may typically have the shape of a curved cylinder face, such as an open-ended cylinder. This means for example that some of said one or more sheets may be curved to conform to a curved surface of the tubular structure. As a further example, typically when said one or more sheets are relatively small, at least some of said one or more sheets may be flat, e.g. straight without curvature, but at the same time said one or more sheets when seen as a collection of sheets conform to the tubular structure. One or more projections of said one or more sheets on an inner surface of the portion of the tubular structure may form one or more areas that constitutes at least 5%, more preferably at least 50%, and most preferably at least 70%, of a total area of the inner surface.

In some embodiments, said one or more sheets of electrical steel comprises one or more rectangular sheets. Sides of said one or more rectangular sheets form one or more slits. Due to said one or more slits, it may be preferred that said one or more areas according to the preceding embodiment may constitute up to about 97% of the total area of the inner surface.

In some embodiments, said one or more rectangular sheets and/or said one or more slits extend in a longitudinal direction of the tubular structure or a tangential direction along the tubular structure.

In some embodiments, some of said one or more slits that extend in the longitudinal direction extend along at least 30%, preferably at least 50%, and most preferably at least 100% of a length of the longest winding.

In some embodiments, said one or more sheets of electrical steel comprises a rectangular sheet, wherein two opposing sides of the rectangular sheet, formed to a cylindrical shape, are adapted to form a slit extending along at least 30%, preferably at least 50%, and most preferably at least 100% of a length of the longest winding.

In some embodiments, said one or more sheets are arranged on an outer surface of an inner supporting structure of the tubular structure, or is over-mould into a tubular wall of the tubular structure. The tubular wall may be shaped as a curved cylinder face.

In some embodiments, the tubular structure comprises at least 1.5 volume percent, “vol. %”, of a soft magnetic composite.

According to another aspect, there is provided a pencil coil whose magnetic shielding comprises, such as is provided by, a tubular structure according to any one of the embodiments herein.

According to a further aspect, there is provided an internal combustion engine comprising a pencil coil according to the aspect mentioned directly above.

### BRIEF DESCRIPTION OF THE DRAWINGS

The various aspects of embodiments disclosed herein, including particular features and advantages thereof, will be readily understood from the following detailed description and the accompanying drawings, which are briefly described in the following.

FIG. 1 is a schematic overview of an exemplifying system in which embodiments herein may be employed.

FIG. 2 is an overview illustrating parts of a pencil coil.

FIG. 3 to FIG. 6 illustrate side views and cross-sectional views of exemplifying embodiments realized using electrical steel.

FIG. 7 to FIG. 9 illustrate further cross-sectional views of exemplifying embodiments realized using electrical steel.

FIG. 10 illustrate a side view and cross-sectional view of exemplifying embodiments realized using a soft magnetic composite.

### DETAILED DESCRIPTION

Throughout the following description, similar reference numerals have been used to denote similar features, such as parts, items, elements, structures, devices, engines, or the like, when applicable.

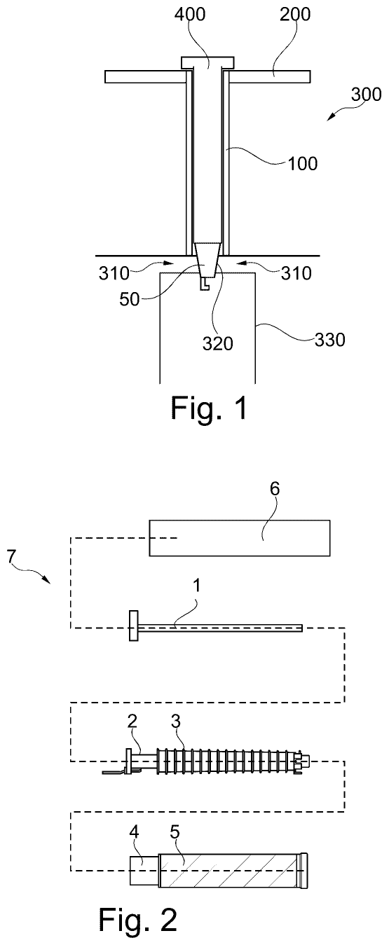

FIG. 1 is a partial view of an internal combustion engine 300 with spark ignition in which embodiments herein may be employed. As shown in FIG. 1, there is, at an upper part of the internal combustion engine 300, a portion 310 that encircles a spark plug connection interface 320, such as a threaded hole or the like. In the spark plug interface 320, a spark plug 50 is mountable. In FIG. 1, the spark plug 50 is shown as mounted. An ignition coil 400 can be mounted at the spark plug 50 and connected to a power source (not shown) according to known manners.

The internal combustion engine 300 further comprises a valve cover 200 according to known manners. The valve cover 200 covers parts, such as mechanical parts and pistons for, e.g., opening and closing of valves for inlet and/or outlet of fuel to/from a cylinder 330 of the internal combustion engine 300. Typically, the internal combustion engine 300 has one or more cylinders, but only one is illustrated in FIG. 1 for reasons of simplicity.

In view of the above, FIG. 1 shows an exemplifying tubular structure 100 adapted to connect, e.g. sealingly connect, tightly connect or the like, the valve cover 200 of the internal combustion engine 300 to the portion 310 of the internal combustion engine 300. The portion 310 encircles the spark plug connection interface 320. The tubular structure 100 thus is adapted to protect the ignition coil 400, e.g. as well as at least a portion of the spark plug 50, from oil for lubrication of the aforementioned parts coverable by the valve cover 200. The ignition coil 400 is mountable at least partly within the tubular structure 100. The tubular structure 100 may have a cross-section that has the shape of a circle, an oval, an ellipse, a triangle, a rectangle, a square, a pentagon, a polygon, all these with or without rounded corners, a combination thereof or the like.

The tubular structure 100 comprises a soft magnetic material, whereby the tubular structure 100 is capable of forming part of a magnetic shield for shielding the ignition coil 400. The soft magnetic material may comprise one or more of strips, sheets or pieces of electrical steel, a soft magnetic composite or the like.

At least a portion 106 of the tubular structure 100 has a relative permeability that is greater than 10, i.e. a unitless factor, preferably greater than 300, and most preferably greater than 600. Additionally, the tubular structure 100 has a resistivity that is greater than 0.3 μΩm, more preferably greater than 75 μΩm, and most preferably greater than 150 μΩm. The portion 106 of the tubular structure 100 extends along and at least partially overlaps with a longest winding of the ignition coil, e.g. out of a primary and secondary winding thereof, as seen in the longitudinal direction of the ignition coil 400, when the ignition coil 400 and the tubular structure 100 are mounted in the internal combustion engine 300.

In some examples, the portion 106 of the tubular structure 100 extends along and overlaps with at least 30%, preferably at least 50%, and most preferably at least 100% of a length of the longest winding.

As an example, the portion of the tubular structure 100 may be delimited by two planes (not shown) of the tubular structure 100. The two planes, such as cross sections, are spaced apart from each other, e.g. whereby the extension and/or overlap as specified above is fulfilled. The planes are typically perpendicular to a longitudinal axis of the tubular structure 100, in which case the planes are cross sections, but also tilted or skewed planes, e.g. relatively the longitudinal axis, may be contemplated.

The permeability and resistivity may be determined by measurement or using known simulation tools before manufacturing of the tubular structure 100.

The resistivity of an ideal conductor, such as a wire or the like, is defined as electrical resistance multiplied by the cross-sectional area of the conductor divided by the length of the conductor. Hence, electrical resistivity can be experimentally obtained by measuring the resistance of the conductor using commonly known technologies based on that a known voltage is applied over the conductor and the current through the conductor is then measured. Using Ohm's law, the electrical resistance is obtained as the voltage divided by the current. After measuring the length and the cross-sectional area of the conductor, the resistivity can be obtained as defined above.

The permeability is measured using International Electrotechnical Commission (IEC) standard 60404-4—“Magnetic materials—Part 4: Method of measurement of d.c. magnetic properties of magnetically soft materials”, 2008-2011. As is well known, the permeability is obtained by multiplying the relative permeability with the permeability in vacuum, which is about 4 *pi*10⁻⁷ H/m. It is noted that all the measurement methodologies known in the relevant technical field for determining these parameters yield the same results within the appropriate limit of measurement accuracy. The skilled person is capable of carrying out these measurements using common general knowledge.

Simulations may be performed using e.g. the finite element method (FEM) which is implemented in many commercially available software packages, or other known simulation tools that are readily available on the market.

It shall here be noted that the ignition coil 400 may be a commonly known pencil coil. An advantage when using a known pencil coil with the embodiments herein is that improved magnetic shielding, that provides improved efficiency, is achieved. For reference a typical pencil coil is illustrated in FIG. 2. A pencil coil has a length of 10-90 cm, typically 15-35 cm, and often 20-30 cm. Further, the pencil coil has a diameter of 20-50 mm, typically 25-45 mm, and often 30-40 mm. Therefore, the same, similar or matching dimensions apply to the tubular structure 100. The known pencil coil comprises the following parts:
a core 1, such as a plunger core or the like,
a primary bobbin 2,
a primary winding 3,
a secondary bobbin 4,
a secondary winding 5, and
a magnetic shield 6.

However, thanks to the embodiments of the tubular structures described herein, the magnetic shield 6 may be dispensed with or at least be made smaller, e.g., with thinner walls of the tubular structure. Therefore, a modified pencil coil 7 without or with less magnetic shielding may be used in combination with the embodiments herein. For the modified pencil coil 7, the magnetic shield 6 can thus be excluded. Accordingly, in some examples, the tubular structure is the only magnetic shielding provided for the ignition coil. The modified pencil coil typically comprises a casing that may or may not provide magnetic shielding. An advantage is that the casing can be made smaller, e.g. thinner in the radial direction, and the casing will therefore require less space. The space made available may be used for the benefit of making e.g. the primary and/or secondary windings more efficient, which typically requires more space.

Expressed somewhat differently, the tubular structure 100 is the only magnetic shielding of the modified pencil coil 7. Alternatively, the tubular structure (100) is configured to contribute to the magnetic shielding with more than 30%, preferably more than 50%, and most preferably more than 80%.

The specified relative permeability and resistivity may be achieved by that the tubular structure 100 comprises one or more of:
electrical steel, such as sheets, stripes, plates or the like of electrical steel,
a soft magnetic composite, such as a soft magnetic powder mixed into a composition before solidification in a mould, or
a combination thereof, or
the like.

Further advantages of at least some embodiments herein include, but are not limited to:
i) enable reduction of cost of the pencil coil thanks to that the magnetic shielding is improved by the tubular structure, e.g., the number of turns in the primary and secondary windings may be reduced for the same total inductance of the assembly.
ii) enable that more of the space available for the pencil coil may be used for electric insulation and design of the primary and secondary windings, thereby improving the endurance and improving heat dissipation and efficiency, e.g. due to design of the primary and secondary windings.
iii) enable a pencil coil to be designed more narrow than otherwise possible, hence meeting tough dimensional requirements.
iv) one of the most dominant heat-generating volumes, i.e. the magnetic shield, is not only decreased in power, but it is more efficient cooled due to the oil outside the tubular structure.

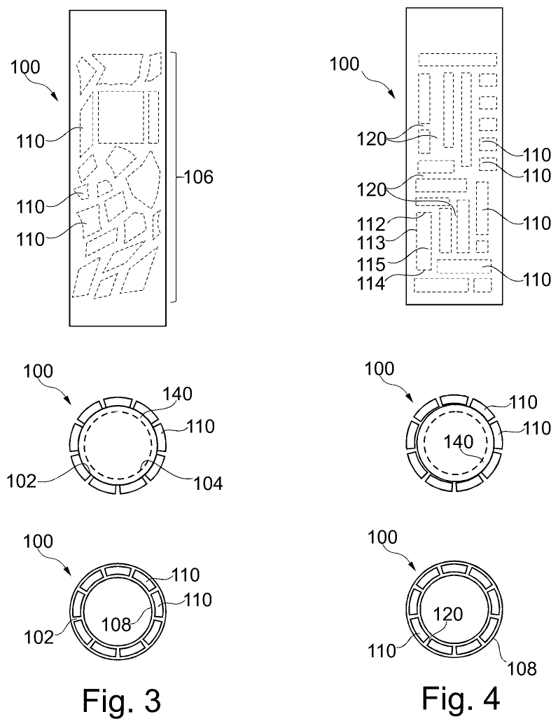

The embodiments of e.g. FIG. 3 to FIG. 9 are realized using electrical steel, which is an example of a soft magnetic material. In these embodiments, the electrical steel, such as transformer plate, strips of electrical steel, sheets, plates or piece of electrical steel or the like, may be provided at, such as glued to, an inner supporting structure 140, such as a bobbin or the like. The inner supporting structure 140 has an outer surface 102 and an inner surface 104. The inner surface 104 is shown by a dotted line to distinguish it from the outer surface 102 of the inner supporting structure 140. This is shown by the upper cross-sectional views of the circular cross-sections of the tubular structure 100. With at least some embodiments herein, the electrical steel may be positioned, or located in or at a wall of the tubular structure to enclose, or at least partly enclose, at least one of the primary and secondary windings of the ignition coil, such as the pencil coil, when installed. Preferably, said at least one of the primary and secondary windings refers to a longest one of the primary and secondary winding as seen in a longitudinal direction of the ignition coil.

Hence, in some embodiments, the tubular structure 100 comprises one or more sheets 110 of electrical steel. Said one or more sheets 110 are generally arranged, such as located, positioned or the like, to conform to the tubular structure 100, e.g. to the shape of the tubular structure 100. As already mentioned above, said one or more sheets 110 may be arranged at or in the tubular structure 100 by means of gluing, over-moulding or the like.

Depending on the size of said one or more sheets 110, some of said one or more sheets 110 may be curved to conform to the portion 106 of the tubular structure 100. This mean that when some of said one or more sheets 110 are relatively large it may be that the sheets 110 are curved.

Furthermore, conformance of said one or more sheets 110 may be compared to how a polygon may conform to a circle. Accordingly, it may be that some of said one or more sheets 110 are flat, or straight, i.e. without curvature. In such example, a collection of said one or more sheets 110 may still conform to the tubular structure 100, e.g. in the same or similar manner as a polygon may conform to, or approximate, a circle. However, in case said one or more sheets 110 are sufficiently small, some or all of said one or more sheets 110 may be arbitrarily arranged in or at the tubular structure 110. As the size of the sheets approaches zero, said one or more sheets 110 will act more and more as a powder.

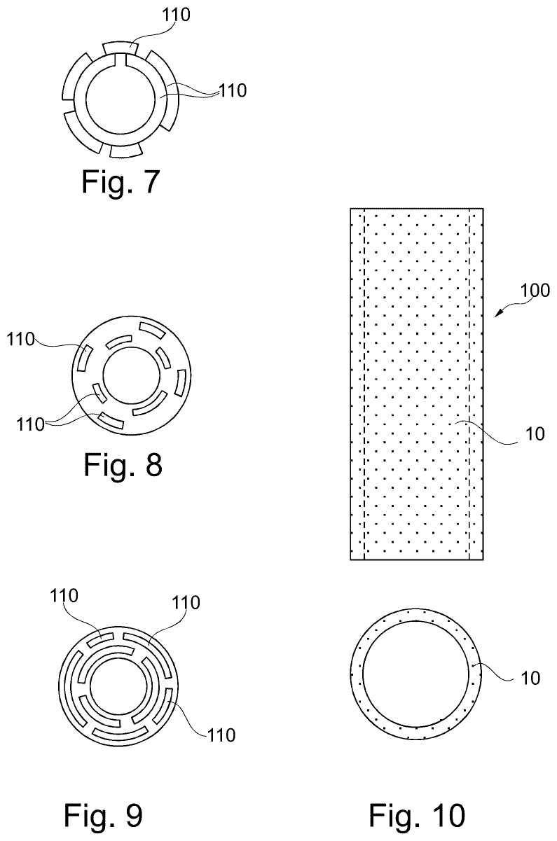

As an example, one or more projections of said one or more sheets 110 on an inner surface 104 of the portion 106 of the tubular structure 100 form one or more areas that constitutes at least 5% of a total area of the inner surface 120. The sheets are thus preferably positioned beside each other in a cylindric wall of the tubular structure 100. The cylindric wall may in addition comprise one or more layers of sheets, shown in e.g. FIG. 7-9.

Alternatively or additionally still referring to FIG. 3 to FIG. 9, the electrical steel may be over-mould in a wall of the tubular structure 100 as shown by the lower cross-sectional views of the circular cross-sections of the tubular structure 100 in FIG. 3 to FIG. 8. The tubular structure 100 may be made of any suitable material, such as a suitable plastic material, Polybutylene Terephthalate (PBT), Polyethylene terephthalate (PET) or the like.

In the example of FIG. 3, irregularly formed pieces of electrical steel are used to furnish the tubular structure 100 with the relative permeability and the resistivity as specified above. The irregularly formed pieces may be triangles, rectangles, pentagons, polygons, ellipses, circles, etc. Typically, an area of the irregularly formed pieces constitutes at least 5% of a total area of the portion 106 of the tubular structure 100, preferably at least 50% and most preferably at least 70%.

In the example of FIG. 4, strips of electrical steel are used to furnish the tubular structure 100 with the relative permeability and the resistivity as above. The strips may be arranged along a main longitudinal direction of the tubular structure or along a tangential direction, preferably perpendicular to the main longitudinal direction, of the tubular structure 100. This means that aforementioned one or more sheets 110 of electrical steel comprises one or more rectangular sheets, wherein sides 112, 113, 114, 115 of said one or more rectangular sheets 110 form one or more slits 120. In more detail, said one or more rectangular sheets 110 and/or said one or more slits 120 extend in a longitudinal direction of the tubular structure 100 and/or a tangential direction along the tubular structure 100. The tangential direction may typically be perpendicular to the longitudinal direction. Again, in this and other examples, an area of the strips or rectangles of electrical steel constitutes at least 5% of a total area of the portion 106 of the tubular structure 100, preferably at least 50% and most preferably at least 70%.

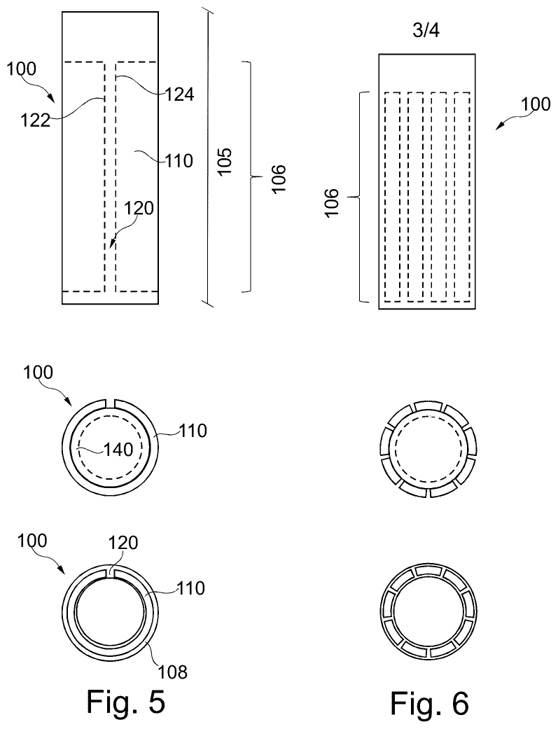

In the example of FIG. 5, a sheet 110 or a wide strip of electrical steel are used to furnish the tubular structure 100 with the relative permeability and the resistivity as above. Notably, a slit separates opposing sides of the sheet of electrical steel. As an example, said one or more sheets 110 of electrical steel comprises a rectangular sheet 110, optionally only one sheet. Two opposing sides 112, 114 of the rectangular sheet 110, formed to a cylindrical shape, are adapted to form a slit 120 extending along at least 30%, preferably at least 50%, and most preferably at least 100% of a length of the longest winding.

In this example, and other examples, the electrical steel provided at the portion 106 of the tubular structure 100 extends along and overlaps with at least 30%, more preferably at least 50%, and most preferably at least 100% of a length of the longest winding. Expressed differently, according to at least some embodiments herein, at least a portion 106 of the tubular structure 100 is capable of forming part of a magnetic shield for the ignition coil. Said portion 106 of the tubular structure 100 may have a length that extends along and overlaps with at least 30%, more preferably at least 50%, and most preferably at least 100% of a length of the longest winding, e.g. the longest of the primary and secondary windings of the ignition coil as seen in the longitudinal direction thereof. Notably, the portion 106 and its related extension and/or overlap may be combined with any one of the embodiments herein.

In the example of FIG. 6, a plurality of strips of electrical steel are used to furnish the tubular structure 100 with the relative permeability and the resistivity as specified above. The plurality of strips extends along the longitudinal direction of the tubular structure 100. Expressed differently, said one or more rectangular sheets 110 and said one or more slits 120 extend in the longitudinal direction of the tubular structure 100. In more detail, some of said one or more slits 120 that extend in the longitudinal direction extend along at least 30%, preferably at least 50%, and most preferably at least 100% of a length of the longest winding.

As in the example of FIG. 4, an area of the plurality of strips of electrical steel constitutes at least 5% of a total area of the portion 106 of the tubular structure 100, preferably at least 50% and most preferably at least 70%.

FIG. 7 to FIG. 9 illustrate exemplifying cross-sectional views for how electrical steel may be provided or over-mould into the tubular structure 100.

In the example of FIG. 7, a plurality of layers of sheets of electrical steel are provided in the tubular structure 100. Thinner sheets are easier to form to a desired shape, but as mentioned a thinner sheet is more easily magnetically saturated. Thus, it may be beneficial to apply multiple layers to achieve the desired relative permeability and resistivity as mentioned above.

In the example of FIG. 8, which is in principle similar to the example of FIG. 7 for an over-mould exemplifying tubular structure 100, the strips of electrical steel are spaced away from each other, yet providing desired magnetic properties. This embodiment, and other embodiments, may be combined with that the tubular structure also is made of a soft magnetic composite, which is used to over-mould the strips and/or sheets and/or pieces of electrical steel.

In the example of FIG. 9, the sheets are more densely packed in the tubular structure 100 as compared to in FIG. 8. The same, similar or corresponding features as in the other examples herein are applicable to the example of FIG. 9.

FIG. 10 illustrate embodiments of the tubular structure 100 that have been realized using a soft magnetic composite. Accordingly, the tubular structure 100 may be made of a soft magnetic composite. This means that the tubular structure 100 comprises at least 1.5 volume percent, “vol. %”, of the soft magnetic composite, preferably at least 2.5 vol. %, most preferably at least 4 vol. %. For example, the tubular structure is made of a composition comprising a powder 10 of the soft magnetic material, wherein the powder 10 was mixed into the composition and before the composition formed the solid soft magnetic composite. The powder 10 is thus typically homogeneously distributed within the tubular structure 100, or at least within the portion 106 of the tubular structure 100 that extends along a least a portion of the longest winding of the primary and secondary windings of the ignition coil. Again, as in the other examples herein, the portion of the tubular structure 100 may be seen as a fraction of the longitudinal length of the longest winding of the ignition coil.

As already mentioned, further embodiments may be realized using both electrical steel and a soft magnetic composite.

Even though embodiments of the various aspects have been described, many different alterations, modifications and the like thereof will become apparent for those skilled in the art. The described embodiments are therefore not intended to limit the scope of the present disclosure.

1. A tubular structure (100) adapted to connect a valve cover (200) of an internal combustion engine (300) to a portion (310) of the internal combustion engine (300), wherein the portion (310) encircles a spark plug connection interface (320), wherein the tubular structure (100) is adapted to protect an ignition coil (400) from oil for lubrication of parts coverable by the valve cover (200), wherein the ignition coil (400) is mountable at least partly within the tubular structure (100), and wherein the tubular structure (100) and the ignition coil (400) are separable from each other, whereby the tubular structure (100) is capable of forming part of a magnetic shield for shielding the ignition coil (400), wherein the tubular structure (100) comprises a soft magnetic material and wherein at least a portion (106) of the tubular structure (100) has a relative permeability greater than 10 and a resistivity greater than 0.3 μΩm, wherein the portion (106) of the tubular structure (100) extends along and at least partially overlaps with a longest winding of the ignition coil (400) as seen in the longitudinal direction of the ignition coil (400), when the ignition coil (400) and the tubular structure (100) are mounted in the internal combustion engine (300).

2. The tubular structure (100) according to claim 1, wherein the portion (106) of the tubular structure (100) extends along and overlaps with at least 30%, more preferably at least 50%, and most preferably at least 100% of a length of the longest winding.

3. The tubular structure (100) according to claim 1, wherein the tubular structure (100) comprises one or more sheets (110) of electrical steel, wherein said one or more sheets (110) are arranged to conform to the tubular structure (100), wherein one or more projections of said one or more sheets (110) on an inner surface (104) of the portion (106) of the tubular structure (100) form one or more areas that constitutes at least 5% of a total area of the inner surface (104).

4. The tubular structure (100) according to claim 3, wherein said one or more sheets (110) of electrical steel comprises one or more rectangular sheets, wherein sides (112, 113, 114, 115) of said one or more rectangular sheets (110) form one or more slits (120).

5. The tubular structure (100) according to claim 4, wherein said one or more rectangular sheets (110) and/or said one or more slits (120) extend in a longitudinal direction of the tubular structure (100) and/or a tangential direction along the tubular structure (100).

6. The tubular structure (100) according to claim 4, wherein some of said one or more slits (120) that extend in the longitudinal direction extend along at least 30% of a length (105) of the longest winding.

7. The tubular structure (100) according to claim 3, wherein said one or more sheets (110) of electrical steel comprises a rectangular sheet (110), wherein two opposing sides (112, 114) of the rectangular sheet (110), formed to a cylindrical shape, are adapted to form a slit (120) extending along at least 30% of a length (105) of the longest winding.

8. The tubular structure (100) according to claim 3, wherein said one or more sheets (110) are arranged on an outer surface of an inner supporting structure (140) of the tubular structure (100), or is over-mould into a tubular wall (108) of the tubular structure (100).

9. The tubular structure (100) according to claim 1, wherein the tubular structure (100) comprises at least 1.5 volume percent, “vol. %”, of a soft magnetic composite.

10. A pencil coil (7) whose magnetic shielding comprises a tubular structure (100) according to claim 1.

11. The pencil coil (7) according to claim 10, wherein the tubular structure (100) is the only magnetic shielding of the pencil coil (7).

12. An internal combustion engine (300) comprising a pencil coil (7) according to claim 10.

13. A system comprising a first part and a second part, wherein the first and second parts are separable from each other, wherein the first part comprises a tubular structure (100) according to claim 1 and the second part comprises a pencil coil lacking an internal or built-in magnetic shield.
